(19) United States
(12) Patent Application Publication
(10) Pub. No.: US 2004/0123032 A1
(43) Pub. Date: Jun. 24, 2004

(54) Method for storing integrity metadata in redundant data layouts

(76) Inventors: Nisha D. Talagala, Fremont, CA (US); Brian Wong, Gordonsville, VA (US)

Correspondence Address: Tom Van Zandt, Blakely, Sokoloff, Taylor & Zafman LLP, Seventh Floor, 12400 Wilshire Boulevard, Los Angeles, CA, 90025-1030, US

(21) Appl. No.: 10/327,846

(22) Filed: Dec. 24, 2002

(51) Int. Cl. G06F 12/00; G06F 12/16

(52) U.S. Cl. 711/114

(57) ABSTRACT

A method for storing integrity metadata in a data storage system disk array. Integrity metadata is determined for each data stripe unit of a stripe in a disk array employing striped parity architecture. The number of physical sectors required to store the integrity metadata is determined. Sufficient data storage space, adjacent to the data stripe unit containing parity data for the stripe, is allocated for the storage of integrity metadata. The integrity metadata is stored next to the parity data. For one embodiment, a RAID 5 architecture is extended so that integrity metadata for each stripe is stored adjacent to the parity data for each stripe.

### RELATED APPLICATIONS

This application is related to the following co-pending applications of the same inventors, which are assigned to the Assignee of the present application: Ser. No. 10/212,861, filed Aug. 5, 2002, entitled “Method and System for Striping Data to Accommodate Integrity Metadata” and Ser. No. 10/222,074, filed Aug. 15, 2002, entitled “Efficient Mechanisms for Detecting Phantom Write Errors”.

### FIELD OF THE INVENTION

This invention relates generally to data layouts (e.g. storage arrays) and more particular to an array architecture for efficiently storing and accessing integrity metadata.

### BACKGROUND OF THE INVENTION

Large-scale data storage systems today, typically includes an array of disk drives and one or more dedicated computers and software systems to manage data. A primary concern of such data storage systems is that of data corruption and recovery. Data corruption occurs where the data storage system returns erroneous data and doesn't realize that the data is wrong. Silent data corruption may result from a glitch in the data retrieval software causing the system software to read from, or write to, the wrong address. Silent data corruption may also result from hardware failures such as a malfunctioning data bus or corruption of the magnetic storage media that may cause a data bit to be inverted or lost. Silent data corruption may also result from a variety other causes; in general, the more complex the data storage system, the more possible causes of silent data corruption.

Silent data corruption is particularly problematic. For example, when an application requests data and gets the wrong data this may cause the application to crash. Additionally, the application may pass along the corrupted data to other applications. If left undetected, these errors may have disastrous consequences (e.g., irreparable undetected long-term data corruption).

The problem of detecting silent data corruption is addressed by creating integrity metadata (data pertaining to data) for each data block. Integrity metadata may include the block address to verify the location of the data block, or a checksum to verify the contents of the data block.

A checksum is a numerical value derived through a mathematical computation on the data in a data block. Basically when data is stored, a numerical value is computed and associated with the stored data. When the data is subsequently read, the same computation is applied to the data. If an identical checksum results then the data is assumed to be uncorrupted.

The problem of where to store the integrity metadata arises. Since integrity metadata must be read with every data READ, and written with every data WRITE, the integrity metadata storage solution can have a significant impact on the performance of the storage system. Also, since integrity metadata is often much smaller than data (typical checkums may be 8-16 bytes in length), and most storage systems can only perform operations that are in integral units of disk sectors (example, 512 bytes), an integrity metadata update may require a Read/Modify/Write operation of a disk sector. Such Read/Modify/Write operations can further increase the I/O load on the storage system. The integrity metadata access/update problem can be ameliorated by caching the integrity metadata in the storage system's random access memory. However, since integrity metadata is typically 1-5% of the size of the data, in most cases, it is not practical to keep all of the integrity metadata in such memory. Furthermore, even if it were possible to keep all this metadata in memory, the metadata would need to remain non-volatile, and would therefore require non-volatile memory of this substantial size.

Data storage systems often contain arrays of disk drives characterized as one of several architectures under the general categorization of redundant arrays of inexpensive disks (RAID). Two commonly used RAID architectures used to recover data in the event of disk failure are RAID 5 and RAID 6. Both are striped parity architectures, that is, in each, data and parity information are distributed across the available disks in the array.

For example, RAID 5 architecture distributes data and parity information (the XOR of the data) across all of the available disks. Each disk of a set of disks (known as a redundancy group) is divided into several equally sized address areas (data blocks). Each disk generally contains the same number of blocks. Blocks from each disk in a set having the same unit address ranges are referred to as a stripe. Each stripe has a parity block (containing parity data for the stripe) on one disk and data blocks on the remaining disks. The parity blocks for each stripe are distributed on different disks. For example, in a RAID 5 system having five disks, the parity information for the first stripe may be written to the fifth drive; the parity information for the second stripe may be written to the fourth disk; and so on with parity information for succeeding stripes written to corresponding drives in a helical pattern. FIG. 1A illustrates the disk array architecture of a data storage system implementing RAID 5 architecture. In disk array architecture 10A, columns 101-105 represent a set of disks in a redundancy group. Corresponding data blocks from each disk represent a stripe. Stripe 106 is comprised of the first data block from each disk. For each stripe one of the data blocks contains parity data. For stripe 106, the data block containing the parity data is data block 107 (darkened). RAID 5 architecture is capable of restoring data in the event of a single identifiable failure in one of its disks. An identifiable failure is a case where the disk is known to have failed.

FIG. 1B illustrates the disk array architecture of a data storage system implementing RAID 6. RAID 6 architecture employs a concept similar to RAID 5 architecture, but uses a more complex mathematical operation, than the XOR operation of RAID 5 architecture, to compute parity data. Disk array architecture 100B includes two data blocks containing parity data for each stripe. For example, data blocks 108 and 109 each contain parity data for stripe 110. By including more complex and redundant parity data, RAID 6 architecture enables a data storage system to recover from two identifiable failures. However, neither RAID 5 nor RAID 6 allows a system to recover from a “silent” failure.

### SUMMARY

A method for storing integrity metadata in a data storage system having a redundant array of disks. In one exemplary embodiment of a method, integrity metadata for a stripe having a plurality of data blocks is determined. The stripe has an integrity metadata chunk that contains integrity metadata for the stripe. The term “chunk” in the context of the present invention is used to describe a unit of data. In one embodiment, a chunk is a unit of data containing a defined number of bytes or blocks.” The number of physical sectors required to store the integrity metadata is determined. The determined number of physical sectors is allocated within a block of the stripe adjacent to parity block. The integrity metadata is then stored to the allocated physical sectors within the block. For one embodiment, a data storage system implementing a RAID 5 or RAID 6 architecture is extended. The integrity metadata chunk of a stripe is stored adjacent to each parity block of the stripe.

Other features and advantages of the present invention will be apparent from the accompanying drawings, and from the detailed description, that follows below.

### BRIEF DESCRIPTION OF THE DRAWINGS

The present invention is illustrated by way of example, and not limitation, by the figures of the accompanying drawings in which like references indicate similar elements and in which:

FIGS. 1A and 1B illustrate the disk array architecture of a data storage system implementing RAID 5 and RAID 6 architecture, respectively;

FIGS. 2A and 2B illustrate exemplary data storage systems in accordance with alternative embodiments of the present invention;

FIG. 3 is a process flow diagram in accordance with one embodiment of the present invention;

FIG. 4 illustrates the disk array architecture of a data storage system implementing extended RAID 5 architecture in accordance with one embodiment of the present invention;

FIG. 5 illustrates the disk array architecture of data storage systems implementing extended RAID 6 architecture in accordance with one embodiment of the present invention; and

FIG. 6 illustrates the disk array architecture of data storage systems implementing extended RAID 6 architecture in accordance with an alternative embodiment of the present invention.

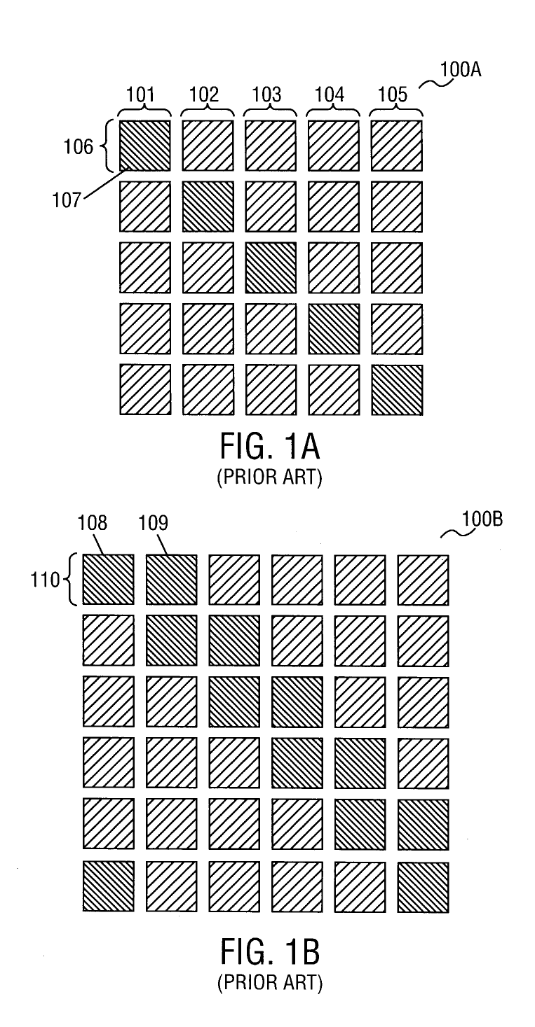

### DETAILED DESCRIPTION

As will be discussed in more detail below, an embodiment of the present invention provides a method for storing integrity metadata in a data storage system disk array. In one exemplary embodiment of the method, integrity metadata is determined for each data stripe unit and parity stripe unit of a stripe. The number of physical sectors required to store the integrity metadata is determined. The determined number of physical sectors is allocated adjacent to the parity stripe unit of the stripe. The integrity metadata is then stored to the allocated physical sectors. For one embodiment, a data storage system implementing a RAID 5 or RAID 6 architecture is extended. An integrity metadata chunk of a stripe is stored adjacent to each parity stripe unit of the stripe.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

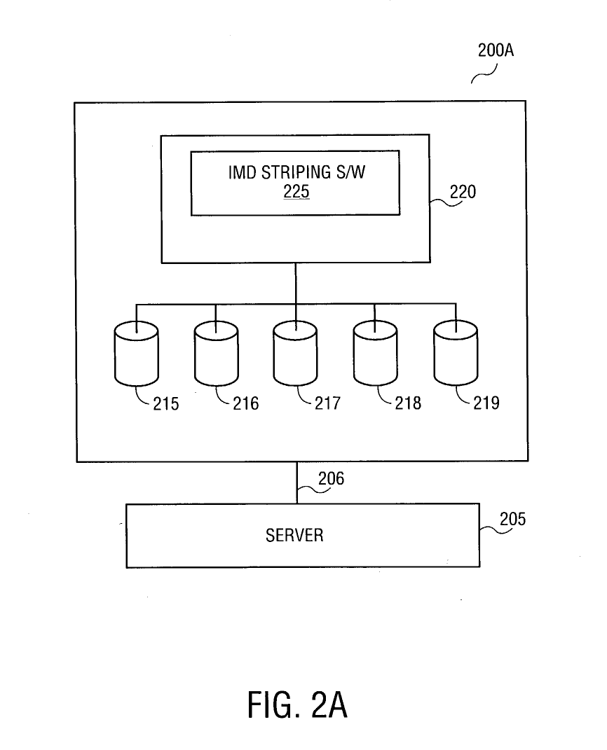

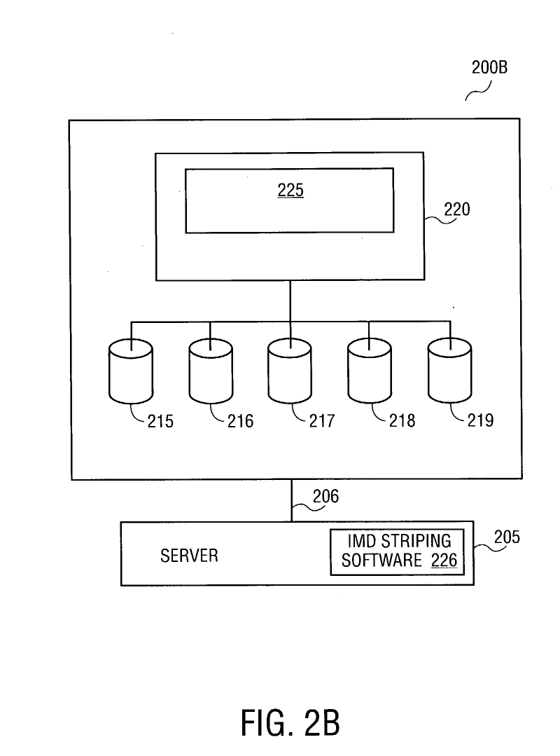

FIGS. 2A and 2B illustrate exemplary data storage systems in accordance with alternative embodiments of the present invention. The method of the present invention may be implemented on the data storage system shown in FIG. 2A. The data storage system 200A, shown in FIG. 2A contains one or more sets of storage devices (redundancy groups) for example disk drives 215-219 that may be magnetic or optical storage media. Data storage system 200A also contains one or more internal processors, shown collectively as the CPU 220. The CPU 220 may include a control unit, arithmetic unit and several registers with which to process information. CPU 220 provides the capability for data storage system 200A to perform tasks and execute software programs stored within the data storage system. The process of striping integrity metadata across a RAID set in accordance with the present invention may be implemented by hardware and/or software contained within the data storage device 200A. For example, the CPU 220 may contain a memory 225 that may be random access memory (RAM) or some other machine-readable medium, for storing program code (e.g., integrity metadata striping software) that may be executed by CPU 220. The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, flash memory devices. The code or instructions may be represented by carrier-wave signals, infrared signals, digital signals, and by other like signals.

For one embodiment, the data storage system 200A, shown in FIG. 2A, may include a server 205. Users of the data storage system may be connected to the server 205 via a local area network (not shown). The data storage system 200A communicates with the server 205 via a bus 206 that may be a standard bus for communicating information and signals and may implement a block-based protocol (e.g., SCSI or fibre channel). The CPU 220 is capable of responding to commands from server 205. Such an embodiment, in the alternative, may have the integrity metadata striping software implemented in the server as illustrated by FIG. 2B. As shown in FIG. 2B, data storage system 200B has integrity metadata software 226 implemented in server 205.

The techniques described here can be implemented anywhere within the block based portion of the I/O datapath. By “datapath” we mean all software, hardware or other entities that manipulate the data from the time that it enters block form on writes to the point where it leaves block form on reads. This method can be implemented anywhere within the datapath where RAID5 or RAID 6 is possible (i.e. any place where the data can be distributed into multiple storage devices). Also, any preexisting hardware and software datapath modules that create data redundancy layouts (such as volume managers) can be extended to use this method.

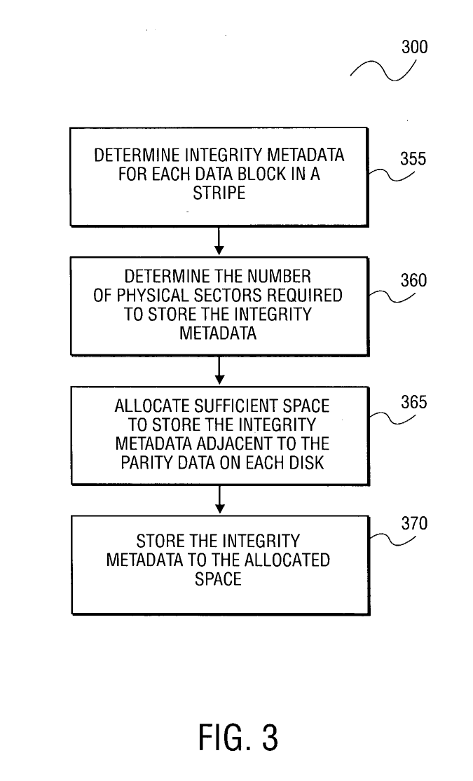

In alternative embodiments, the method of the present invention may be used to implement an Extended RAID 5 or Extended RAID 6 architecture. FIG. 3 is a process flow diagram in accordance with one such embodiment of the present invention. Process 300, shown in FIG. 3, begins at operation 355 in which integrity metadata is determined for each data stripe unit in a stripe.

At operation 360 the number of physical sectors required to store the integrity metadata for each data stripe unit in the stripe is determined. The integrity metadata may be approximately 1-5% of the size of the data. The integrity metadata for an entire stripe of data may, therefore require only a few sectors. For example, for a typical storage scheme having four 16 KB data stripe units and one 16 KB parity stripe unit and 8 bytes of integrity metadata per 512 byte data or parity sector, the total amount of integrity metadata for a stripe would be 1280 bytes. This integrity metadata can be stored in 3 physical sectors. The number of physical sectors required to store the integrity metadata will vary depending upon the size of the checksum and/or other information contained in the integrity metadata, and may be any integral number of physical sectors.

At operation 365, the space necessary to store the integrity metadata is allocated adjacent to the parity data for the stripe on each disk.

The integrity metadata is then stored in the allocated space adjacent to the parity data at operation 370. Because the integrity metadata is located adjacent to the parity data, both the integrity metadata and the parity data may be modified with the same I/O operations thus reducing the number of I/O operations required over prior art schemes. In conventional striped parity architecture schemes, a write operation to part of the stripe requires that the parity data for the stripe be modified. That is, a write to any data stripe unit of the stripe requires writing a new parity stripe unit. The parity information must be read and computed (e.g., XOR'd) with the new data to provide new parity information. Both the data and the parity data must be rewritten. This parity update process is referred to as a read-modify-write (RMW) operation. Since integrity metadata chunk can be much smaller than a disk sector, and most storage systems perform I/O only in units of disk sectors, integrity metadata updates can require a Read-Modify-Write operation. These two RMW operations can be combined. In this way, the extended RAID 5 architecture of one embodiment of the present invention provides the benefits of metadata protection without incurring additional I/O overhead for a metadata update.

Even though the data gets the advantage of split integrity metadata protection, the parity data does not, as it is co-located with its own integrity metadata. Also, since all integrity metadata is stored together, a dropped write in an integrity metadata segment would cause the loss of all integrity metadata for the stripe. Such a loss does not damage detection of a data-metadata mismatch, however, such an error is difficult to diagnose since the integrity metadata is corrupted. The term “split metadata protection” is used to describe a situation where the integrity metadata is stored on a separate disk from the corresponding data. There is an additional degree of protection provided by having metadata stored on a different disk from the data. For example, split metadata protection can be useful for detecting corruptions, misdirected I/O's, and stale data.

One way to address this problem is to attach a generation number to each metadata chunk. A small generation number is attached to each sector in the metadata chunk. The generation number may be used to provide valuable diagnostic information (e.g., detection of a stale parity stripe unit or stale metadata chunk). The generation number can be used to detect stale whole or partial metadata chunks. A copy of the generation number is also stored separately in non-volatile storage. For one embodiment of the invention, if each 512 byte data sector has an 8 byte checksum, and each 512 byte metadata chunk contains 63 such checksums, then the overhead for 1 bit generation ID is 0.0031% of the data. That is, 1TB of physical storage will require 31 MB of generation ID space. The amount of generation IDs should be sufficiently small to make storage on non-volatile memory practical.

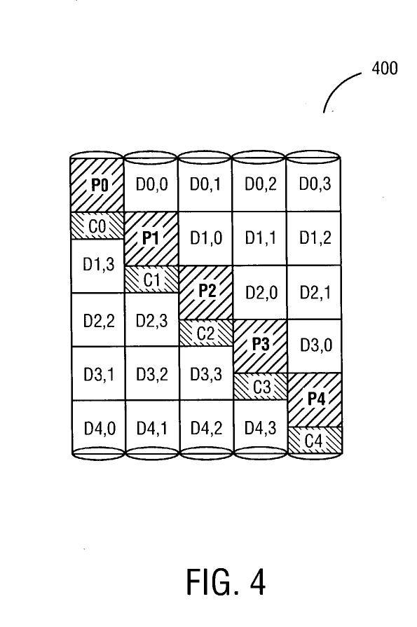

FIG. 4 illustrates a disk array architecture of a data storage system implementing extended RAID 5 architecture in accordance with one embodiment of the present invention. Disk array architecture 400 includes a parity data stripe unit for every stripe, namely P₀-P₄ containing the parity data for each stripe of data. For example parity data stripe unit P₀ contains the parity data for data stripe units D₀₀-D₀₃, and so on. Stored adjacent to each parity data stripe unit P₀-P₄ is one or more sectors, C₀-C₄, containing the integrity metadata for each data stripe unit of the respective stripe. As discussed above, the architecture of one embodiment of the present invention provides the benefits of metadata protection without incurring additional I/O overhead for a write operation.

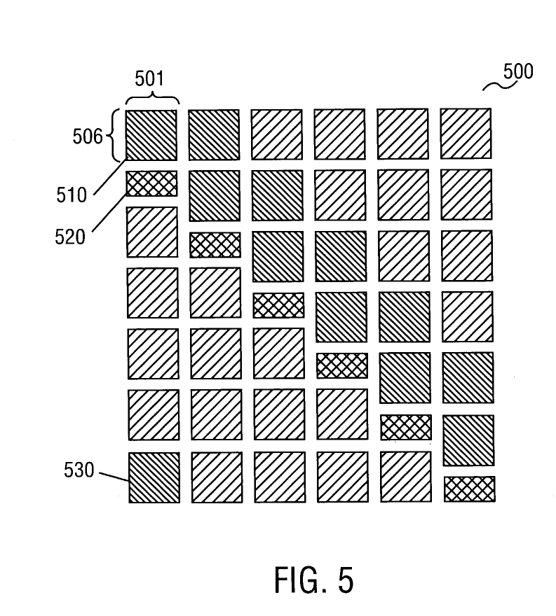

The method of the present invention is likewise applied to RAID 6-based architectures. FIG. 5 illustrates a disk array architecture of a data storage system implementing extended RAID 6 architecture in accordance with one embodiment of the present invention. Disk array architecture 500, shown in FIG. 5, includes integrity metadata for each stripe, stored adjacent to the parity data stored on each disk. For example, disk 501 may have stored thereon, parity data for stripe 506 (parity stripe unit 510) and integrity metadata for stripe 506 (integrity metadata chunk 520), as well as parity data for stripe 5 (parity stripe unit 530). The architecture of one embodiment of the present invention likewise provides the benefits of metadata protection without incurring additional I/O overhead for a write operation.

In an alternative embodiment of the present invention, the architecture has two metadata chunks, each one located under one of the two parity segments.

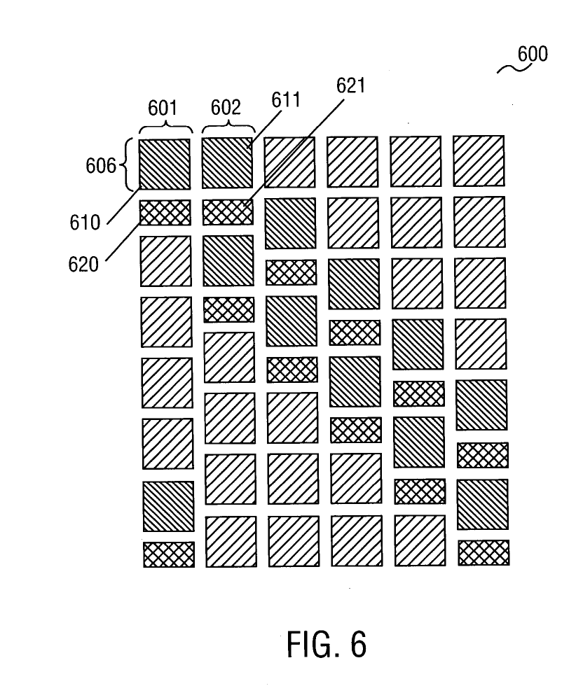

Disk array architecture 600, shown in FIG. 6, includes two copies of the integrity metadata for each stripe, stored adjacent to the parity data stored on each disk. For example, one copy of integrity metadata for stripe 606, integrity metadata chunk 620, may be stored on disk 601 adjacent to parity data for stripe 606, parity stripe unit 610. A second copy of integrity metadata for stripe 606, integrity metadata chunk 621 may be stored on disk 602 adjacent to a second copy of parity data for stripe 606, parity stripe unit 611.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
determining an integrity metadata for a stripe, the stripe having a plurality of data stripe units and at least one parity stripe unit, each of the at least one parity stripe units containing parity data for the stripe;
determining a number of physical sectors required to store the integrity metadata;
allocating the determined number of physical sectors adjacent to one of the at least one parity stripe unit; and
storing the integrity metadata to the allocated physical sectors adjacent to the one parity stripe unit.

2. The method of claim 1, wherein the integrity metadata is selected from the group consisting of checksum data, generation number data, stripe unit address data, or combinations thereof.

3. The method of claim 2, wherein the integrity metadata includes a generation number used to detect stale metadata in the event of a dropped write in a metadata chunk.

4. The method of claim 3, wherein the physical sectors are 512 bytes in length.

5. The method of claim 3, wherein the stripe has one parity stripe unit.

6. The method of claim 3, wherein the stripe has two parity stripe units.

7. The method of claim 6, further comprising:
allocating the number of physical sectors adjacent to both of the parity stripe units; and
storing the integrity metadata to the allocated physical sectors adjacent to both of the parity stripe units.

8. A machine-readable medium containing instructions which, when executed by a processing system, cause the processing system to perform a method, the method comprising:
determining an integrity metadata for a stripe, the stripe having a plurality of data stripe units and at least one parity stripe unit, each of the at least one parity stripe units containing parity data for the stripe;
determining a number of physical sectors required to store the integrity metadata;
allocating the determined number of physical sectors adjacent to one of the at least one parity stripe units; and
storing the integrity metadata to the allocated physical sectors adjacent to the one parity stripe unit.

9. The machine-readable medium of claim 8, wherein the integrity metadata is selected from the group consisting of checksum data, generation number data, stripe unit address data, or combinations thereof.

10. The machine-readable medium of claim 9, wherein the integrity metadata includes a generation number used to detect stale metadata in the event of a dropped write in a metadata chunk.

11. The machine-readable medium of claim 10, wherein the physical sectors are 512 bytes in length.

12. The machine-readable medium of claim 10, wherein the stripe has one parity stripe unit.

13. The machine-readable medium of claim 10, wherein the stripe has two parity stripe units.

14. The machine-readable medium of claim 13, wherein the method further comprises:
allocating the number of physical sectors adjacent to both of the parity stripe units; and
storing the integrity metadata to the allocated physical sectors adjacent to both of the parity stripe units.

15. An apparatus comprising:
means for determining an integrity metadata for a stripe, the stripe having a plurality of data stripe units and at least one parity stripe unit, each of the at least one parity stripe units containing parity data for the stripe;
means for determining a number of physical sectors required to store the integrity metadata;
means for allocating the determined number of physical sectors adjacent to one of the at least one parity stripe unit; and
means for storing the integrity metadata to the allocated physical sectors adjacent to the one parity stripe unit.

16. The apparatus of claim 15, wherein the integrity metadata is selected from the group consisting of checksum data, generation number data, stripe unit address data, or combinations thereof.

17. The apparatus of claim 16, wherein the integrity metadata includes a generation number used to detect stale metadata in the event of a dropped write in a metadata chunk.

18. The apparatus of claim 17, wherein the stripe has one parity stripe unit.

19. The apparatus of claim 17, wherein the stripe has two parity stripe units.

20. The apparatus of claim 19, further comprising:
means for allocating the number of physical sectors adjacent to both of the parity stripe units; and
means for storing the integrity metadata to the allocated physical sectors adjacent to both of the parity stripe units.

21. A striped parity disk array architecture comprising:
a plurality of data storage devices, each of data storage devices divided into a plurality of stripe units, corresponding stripe units on each data storage device constituting a stripe, the stripe having a plurality of data stripe units and at least one parity stripe unit, the parity stripe unit containing parity data for the stripe; and
at least one integrity metadata chunk stored in at least one physical sector, the at least one physical sector adjacent to one of the at least one parity stripe units, the integrity metadata chunk containing an integrity metadata for each stripe unit of the stripe.

22. The striped parity disk array architecture of claim 21, wherein the integrity metadata is selected from the group consisting of checksum data, generation number data, stripe unit address data, or combinations thereof.

23. The striped parity disk array architecture of claim 22 wherein the integrity metadata includes a generation number used to detect stale metadata in the event of a dropped write in a metadata chunk.

24. A data storage system comprising:
a server; and
a storage unit coupled to the server, the data storage system including a processing system and a memory coupled thereto, characterized in that the memory has stored therein instructions which when executed by the processing system, cause the processing system to perform the operations of a) determining an integrity metadata for a stripe, the stripe having a plurality of data stripe units and at least one parity stripe unit, each of the at least one parity stripe units containing parity data for the stripe, b) determining a number of physical sectors required to store the integrity metadata, c) allocating the determined number of physical sectors adjacent to one of the at least one parity stripe unit, and d) storing the integrity metadata to the allocated physical sectors adjacent to the one parity stripe unit.

25. The data storage system of claim 24, wherein the integrity metadata is selected from the group consisting of checksum data, generation number data, stripe unit address data, or combinations thereof.

26. The data storage system of claim 25 wherein the integrity metadata includes a generation number used to detect stale metadata in the event of a dropped write in a metadata chunk.

27. The data storage system of claim 26, wherein the stripe has two parity stripe units.

28. The data storage system of claim 27, wherein the memory has stored therein instructions which when executed by the processing system, further cause the processing system to perform the operations of e) allocating the number of physical sectors adjacent to both of the parity stripe units, and f) storing the integrity metadata to the allocated physical sectors adjacent to both of the parity stripe units.
